(19) United States
(12) Patent Application Publication
(10) Pub. No.: US 2026/0296444 A1
(43) Pub. Date: Oct. 1, 2026

(54) CONTROL SYSTEMS FOR A VEHICLE POWERTRAIN

(71) Applicant: JAGUAR LAND ROVER LIMITED, Whitley, Coventry, Warwickshire (GB)

(72) Inventors: Romain LACROISILLE, Whitley, Coventry, Warwickshire (GB); Olivier ROQUES, Whitley, Coventry, Warwickshire (GB); Matt SULLIVAN, Whitley, Coventry, Warwickshire (GB); Vladimir BARANCHIKOV, Whitley, Coventry, Warwickshire (GB)

(21) Appl. No.: 19/484,237

(22) PCT Filed: May 14, 2024
(86) PCT No.: PCT/EP2024/063244

§ 371 Date: Nov. 13, 2025

(30) Foreign Application Priority Data
May 17, 2023 (GB) 2307316.6

(51) Int. Cl. B60W 30/188; B60W 10/04; B60W 10/10

(52) U.S. Cl. CPC B60W 30/188; B60W 10/04; B60W 10/10; B60W 2540/10; B60W 2552/15; B60W 2710/0666; B60W 2710/083; B60W 2710/1005

(57) ABSTRACT

A control system for controlling a powertrain of a vehicle includes one or more processors configured to receive a gear change signal indicative of an expected upshift in the gearbox, receive a predicted torque demand signal, the predicted torque demand signal containing information indicative of a predicted post-upshift torque demand; receive a current torque demand signal, the current torque demand signal containing information indicative of a current torque demand; determine, in dependence on the predicted torque demand and the current torque demand, a difference between the predicted post-upshift torque demand and the current torque demand; and output a first output signal. The first output signal is arranged to cause a change in torque generated by the power source in dependence on the determined difference and the gear change signal.

### TECHNICAL FIELD

The present disclosure relates to control systems for vehicle powertrains. Particularly but not exclusively, the disclosure relates to control of a powertrain during an upshift of a vehicle. Aspects of the invention relate to control systems, to vehicles and to methods.

### BACKGROUND

It is known to provide a control system for a vehicle which processes a driver input in order to determine what torque should be produced by the power sources of the vehicle. However, existing systems may not anticipate future driver demand accurately—leading to a slower reaction of a vehicle to driver demand and a less satisfactory driving experience. In particular, during an upshift in a gearbox, poor management of vehicle torque may lead to a vehicle being slow to react to changing driver demand or a reduction in acceleration of a vehicle.

Further, existing systems may attempt to manage torque during an upshift by increasing engine torque before the upshift occurs in order to maintain torque at the wheels at a relatively constant level. However, where an upshift is cancelled after preparation for the upshift has begun, such as due to a change in driver demand, existing systems may react slowly, resulting in undesirable acceleration of the vehicle.

The process of an upshift may also very depending on the manner in which the vehicle is controlled. For example, when a vehicle is controlled by a driver with minimal driver assistance, there may be a desire to maintain acceleration through an upshift, or more generally for a vehicle to react quickly to inputs from the driver. However, when an advanced driver assistance system (ADAS), such as adaptive cruise control, is used, there may be a desire to reduce the effect of an upshift, such that vehicle behaviour is not significantly affected by an upshift such that the smoothness of the motion of the vehicle is reduced.

It is an aim of the present invention to address one or more of the disadvantages associated with the prior art.

### SUMMARY OF THE INVENTION

Aspects and embodiments of the invention provide control systems, vehicles, and methods as claimed in the appended claims

According to an aspect of the present invention there is provided a control system for controlling a powertrain of a vehicle, the powertrain comprising a power source and a drivetrain arranged to receive torque from the power source, the drivetrain comprising a gearbox and a torque converter, the control system comprising one or more processors, the one or more processors collectively configured to: receive a gear change signal indicative of an expected upshift of the gearbox, the gear change signal comprising an indication of a torque ratio of the gearbox after the expected upshift of the gearbox; receive a driver torque demand signal, the driver torque demand signal comprising a driver torque demand; receive a torque convertor slip value signal, the torque convertor slip value signal comprising a torque converter slip value; receive a predicted input shaft speed signal, the predicted input shaft speed signal comprising a predicted input shaft speed of the gearbox after the expected upshift of the gearbox; determine a normalised torque demand in dependence on the torque demand, the torque converter slip value, and the predicted input shaft speed; determine a predicted torque demand in dependence on the normalised torque demand and the torque ratio of the gearbox after the upshift; and output a first output signal, the first output signal requesting the power source to generate a torque in dependence on the predicted torque demand.

In this way, a torque demand after an upshift may be predicted more accurately. This may allow a smoother upshift to take place by anticipating the necessary torque for maintaining a consistent rate of acceleration for a vehicle or a constant torque at the wheels, as may be required depending on driving conditions.

The torque demand may be a driver torque demand, such as an input of an accelerator pedal and the predicted torque demand may be a predicted driver torque demand.

The processors may be collectively configured to: receive a road gradient signal indicative of a road gradient, and determine the normalised torque demand in dependence on the road gradient. By accounting for changes in the road gradient, the torque demand may be predicted more accurately, providing a smoother driving experience in a wider range of environments.

The processors may be collectively configured to: receive a vehicle speed signal indicative of a vehicle speed, and determine the normalised torque demand in dependence on the vehicle speed. By accounting for vehicle speed, the predicted driver torque demand may be still further improved and made more accurate. For example, vehicle speed may affect air resistance and rolling resistance, changing the behaviour of the vehicle.

The processors may be collectively configured to: receive a power source torque maximum torque capability signal indicative of a power source torque maximum torque capability, and determine the predicted torque demand in dependence on the powertrain torque maximum capability. A power source maximum torque may be used in the calculation of the predicted torque demand in order to ensure that a powertrain is driven at a torque within its capability to avoid damage to the powertrain. Further, the powertrain torque may vary based on operating conditions and so, by providing a changeable value as opposed to a hardcoded value, the prospect of damage to the powertrain may be further reduced.

The power source may comprise an internal combustion engine and an electric machine, and the processors may be collectively configured to output the first output signal to cause the internal combustion engine to generate the torque in dependence on the predicted driver torque demand before the expected upshift of the gearbox takes place. In this way, the torque may be increased prior to the upshift, reducing acceleration lag due to a possible reduction of the torque at the wheels during the upshift.

The processors may be collectively configured to output a second signal to cause the electric machine to generate an electric machine torque in dependence on the predicted driver torque before the expected upshift of the gearbox takes place, the electric machine torque of the electric machine being in opposition to the torque generated by the internal combustion engine. This allows the internal combustion engine to increase in torque, while not causing undesirable acceleration prior to the upshift. The electric machine torque may be reduced quickly and reliably during the upshift such that the torque on the wheels may remain substantially constant.

According to a further aspect of the invention, there is provided a vehicle comprising the control system of the above-described aspect.

According to a still further aspect of the invention, there is provided a method for controlling a powertrain of a vehicle, the powertrain comprising a power source and a drivetrain arranged to receive torque from the power source, the drivetrain comprising a gearbox and a torque converter, the method comprising: receiving a gear change input signal indicative of an upshift in the gearbox, the gear change input signal including an indication of a torque ratio of the gearbox after the upshift; receiving a first input signal, the first input signal including a torque demand; receiving a second input signal, the second input signal including a torque converter slip value; receiving a third input signal, the third input signal including a predicted input shaft speed of the gearbox after the upshift; determining a normalised torque demand based at least partially on the torque demand, the torque converter slip value, and the predicted input shaft speed; determining a predicted torque demand based at least partially on the normalised torque demand and the predicted torque ratio of the gearbox after the upshift; and outputting a first output signal indicative of the predicted torque demand, the first output signal being arranged to cause the power source to generate a torque.

According to a yet still further aspect of the invention, there is provided computer readable instructions which, when executed by a computer, are arranged to perform the method of the still further aspect of the invention.

According to another aspect of the invention, there is provided a control system for controlling a powertrain of a vehicle, the powertrain comprising a power source and a drivetrain arranged to receive torque from the power source, the drivetrain comprising a gearbox, the control system comprising one or more processors, the one or more processors being collectively configured to: receive a gear change signal indicative of an expected upshift in the gearbox, receive a predicted torque demand signal, the predicted torque demand signal containing information indicative of a predicted post-upshift torque demand; receive a current torque demand signal, the current torque demand signal containing information indicative of a current torque demand; compare the predicted post-upshift torque demand and the current torque demand; and output a first output signal, the first output signal being arranged to cause a change in torque generated by the power source in dependence on the comparison.

In this way, the control system may output a torque modulation value, which is based on a required change in torque relative to a current torque. By outputting a difference, as opposed to an absolute torque value, the output may be manipulated more easily by downstream processes.

The predicted torque demand signal may be the first output signal of the first-mentioned aspect of the invention. The predicted post-upshift torque demand may therefore be determined according to the method of the still further aspect of the invention. Further optional aspects of the first-mentioned aspect of the invention may also be incorporated into the another aspect of the invention.

The processors may be collectively configured to apply a modulation factor to the determined difference to calculate a modulated determined difference, and the first output signal may be output in dependence on the modulated determined difference. In this way, the determined difference may be altered based on factors such as the source of the torque demand or a driving mode, such that the change in torque during the gear change may be modified as necessary.

The processors may be collectively configured to: receive a torque demand signal indicative of a torque demand; determine a filtered torque demand based on the torque demand signal; and determine the modulation factor based on a comparison of the torque demand signal and the filtered torque demand. Optionally, the torque demand may be a driver torque demand, such as from an accelerator pedal. The filtered torque may be determined based on a low-pass filter. In this case, a deviation between the torque demand, i.e. the raw, unfiltered torque demand, and the filtered torque demand may be indicative of a change in behaviour of the system or the driver. Such a change in behaviour may warrant a deceleration or a reduction in acceleration. In this case, the torque modulation may be changed accordingly, such that the vehicle may comply with the demand of the driver quickly, during an upshift. While the determination of a high frequency component of the demand may be determined by a high-pass filter and without a comparison step, a low pass filtering step may be used in order to provide an input to a power source in order to determine the drive to be generated by the engine and therefore the introduction of a comparison step may reduce the overall computational requirements.

The modulation factor may be between 0 and 1. With this range of values, the modulation factor may cancel the torque increase for the upshift, such as when the upshift is likely to be cancelled due to a drop in torque demand or may maintain the torque increase where the torque demand is similar to the predicted torque demand.

Applying the modulation factor to the determined difference may comprise multiplying the determined difference by the modulation factor. This may provide an effective means for applying the modulation factor which has low computational requirements.

The torque demand signal may contain information indicative of at least one of: an accelerator pedal input; a road gradient; a vehicle speed; and a driving mode, and the one or more processors may be collectively configured to determine the predicted post-upshift torque demand based on any of the accelerator pedal input; the road gradient; the vehicle speed; and/or the driving mode. By accounting for factors such as accelerator pedal input, road gradient, vehicle speed and driving mode, the control system may modify the torque generated by the power source to suit the specific driving condition and driver demand. Therefore, the driving experience may be smoother for a user of the vehicle.

According to another aspect of the invention, there is provided a vehicle comprising the control system of the another aspect described above.

According to another aspect of the invention, there is provided a method for controlling a powertrain of a vehicle, the powertrain comprising a power source and a drivetrain arranged to receive torque from the power source, the drivetrain comprising a gearbox, the method comprising: receiving a gear change signal indicative of an upshift of the gearbox; receiving a predicted torque demand signal, the predicted torque demand signal containing information indicative of a predicted post-upshift torque demand; receiving a current torque demand signal, the current torque demand signal containing information indicative of a current torque demand; determining, in dependence on the predicted torque demand and the current torque demand a difference between the predicted post-upshift torque demand and the current torque demand; and outputting a first output signal based on the determined difference and the gear change signal, the first output signal being arranged to cause a change in torque generated by the power source.

According to another aspect of the invention, there is provided computer readable instructions which, when executed by a computer, are arranged to perform a method according to the above-described aspect.

According to an additional aspect of the invention, there is provided a control system for controlling a power source of a vehicle, the control system comprising one or more processors, the one or more processors being collectively configured to: receive a torque demand signal, the torque demand signal comprising a torque demand; receive a torque demand source signal, the torque demand source signal (or torque demand signal) comprising an indication of a source of the torque demand; select a torque modulation scheme for modulating torque from the power source during the upshift in dependence on the source of the torque demand for modulating torque from the power source during an upshift; and output a first output signal, the first output signal being arranged to cause the power source to change a torque output in dependence on the selected torque modulation scheme.

In this way, the torque modulation may be altered depending on a source of a torque demand. For example, if a torque demand is received from an advanced driver assistance system (ADAS) such as cruise control, it may be desirable to maintain a substantially constant torque at the output of the drivetrain, such that the vehicle moves more smoothly. However, if the source of the torque is a driver input such as an accelerator pedal, then it may be desirable to make the vehicle more responsive, such as by adapting to changes in road gradient.

The processors may be collectively configured to receive a gear change signal indicative of an expected upshift of the gearbox and to select the torque modulation scheme in response to receiving the gear change signal. The torque modulation scheme may be for managing torque from the power source during an upshift of the gearbox.

The processors may be collectively configured to determine a torque modulation based on the torque demand using the selected torque modulation scheme, and the first output signal may be arranged to cause the power source to change the torque output in dependence on the determined torque modulation.

The processors may be collectively configured to select a first torque modulation scheme to maintain a constant torque output from the powertrain during the upshift when the source of the torque demand is an advanced driver assistance system (ADAS) or an autonomous driving system. In this way, the perception of an upshift by a driver may be reduced when an advanced driver assistance system is in use. The driver may therefore have an improved driving experience.

The gear change signal may include an indication of a torque ratio of the gearbox after the upshift, and the first torque modulation scheme may comprise determining a product of the torque demand and the torque ratio of the gearbox before the upshift, and determining a required torque based on dividing the determined product of the torque demand and the torque ratio by the post-upshift torque ratio of the gearbox. In this way, the torque at the wheels of the vehicle may be maintained substantially constant while maintaining low computational requirements.

The processors may be collectively configured to select a second torque modulation scheme to predict a driver torque demand after the upshift when the source of the torque demand is a driver input. The second torque modulation scheme may include the method described in connection with the first-described aspect of the invention in order to predict the driver torque demand. As an input from a driver may vary as compared to an advanced driver assistance system, the system may react differently. For example, when a driver is providing the input for a torque demand, the torque may be determined based on a driving mode or a road gradient such that the vehicle is responsive to the demands of the driver.

The torque demand signal may contain information indicative of at least one of: an accelerator pedal input; a road gradient; a vehicle speed; and a driving mode, and the processors may be collectively configured to predict the driver torque demand after the upshift in dependence on the first input signal. By accounting for factors such as accelerator pedal input, road gradient, vehicle speed and driving mode, the control system may modify the torque generated by the power source to suit the specific driving condition and driver demand. Therefore, the driving experience may be smoother for a user of the vehicle.

According to a further additional aspect of the invention, there is provided a vehicle comprising the control system of the additional aspect.

According to a still further additional aspect of the invention, there is provided a method for controlling a power source of a vehicle, the method comprising: receiving a gear change signal indicative of an upshift of the gearbox; receiving a torque demand signal, the torque demand signal (or first input signal) including a torque demand; receiving a torque demand source signal (or second input signal), the torque demand source signal including an indication of a source of the torque demand; in response to receiving the gear change signal, selecting a torque modulation scheme based on the source of the torque demand for modulating torque from the power source during the upshift; and outputting a first output signal, the first output signal causing the power source to change a torque output in dependence on the selected torque modulation scheme.

According to one more aspect of the invention, there is provided computer readable instructions which, when executed by a computer, are arranged to perform a method according to the above-described still further additional aspect.

The above-described control systems may comprise one or more controllers collectively comprising at least one electronic processor having an electrical input for receiving an input signal; and at least one memory device electrically coupled to the at least one electronic processor and having instructions stored therein; and wherein the at least one electronic processor is configured to access the at least one memory device and execute the instructions thereon so as to carry out the defined methods.

It will be understood that separately described methods may be carried out by common control systems and that separately described control systems may in fact be combined common control systems. Further, where a signal is described as being received by a control system, the signal may be generated within a control system, such as by an internal process, and may be received by a part of the control system, such as a downstream process.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows a vehicle in accordance with embodiments of the invention;

FIG. 2 shows a schematic diagram of a control system and powertrain of a vehicle in accordance with embodiments of the invention;

FIG. 3 shows a flowchart illustrating a method in accordance with an embodiment of the invention;

FIG. 4 shows a flowchart illustrating a method in accordance with an embodiment of the invention;

FIGS. 5a, 5b and 5c show graphs illustrating changes in the powertrain during an upshift;

FIG. 6 shows a flowchart illustrating a method in accordance with an embodiment of the invention;

FIG. 7 shows a flowchart illustrating a method in accordance with an embodiment of the invention; and

FIG. 8 shows a flowchart illustrating a method in accordance with an embodiment of the invention.

### DETAILED DESCRIPTION

Embodiments of this invention relate to a control system for determining required torque during an upshift of a vehicle. An upshift is where a gearbox is actuated to alter the gear that is driven by a power source of a vehicle, such that a “higher” gear is selected and the drivetrain of the vehicle obtains a lower gear ratio. Generally, if a torque is not varied as an upshift takes place, then a torque on the wheels of the vehicle will reduce. Where a vehicle is accelerating, this can be felt by the driver as a reduction in the acceleration of the vehicle.

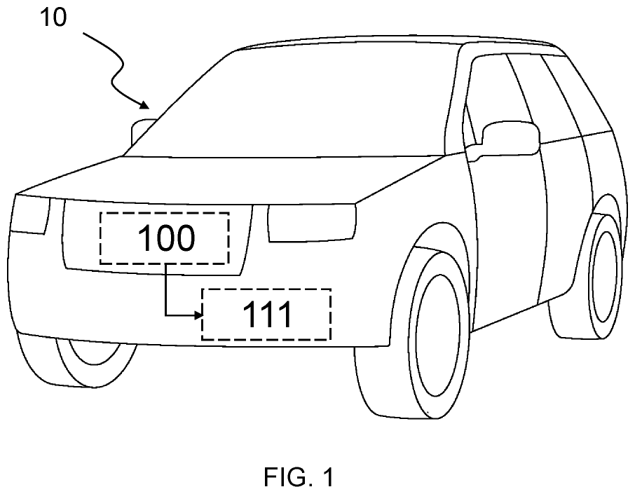

FIG. 1 illustrates a vehicle according to all embodiments of the present invention to provide context for the invention.

The vehicle 10 includes a control system 100 and a powertrain 111. The control system 100 is arranged to control the powertrain 111. The vehicle 10 may be a hybrid electric vehicle having an electric machine and an internal combustion engine. The vehicle 10 may be a mild hybrid electric vehicle (MHEV). An MHEV may be characterised by having no capacity to charge an electric battery using mains electricity and the electric battery may be charged by the internal combustion engine and regenerative braking only. Considered another way, the only primary energy source for an MHEV may be liquid fuels, for example petrol and diesel and the MHEV may have no electrical connection for charging the battery from an external source. The capacity of the battery of an MHEV may be less than 2 kWh. The battery voltage of an MHEV may be around 48 volts or less.

Alternatively, the vehicle 10 may be a plug-in hybrid electric vehicle (PHEV). A PHEV may be characterised by being arranged to receive electrical energy from an external source, such as via a connection to mains electricity. A PHEV may therefore comprise an external electrical connection for charging the battery.

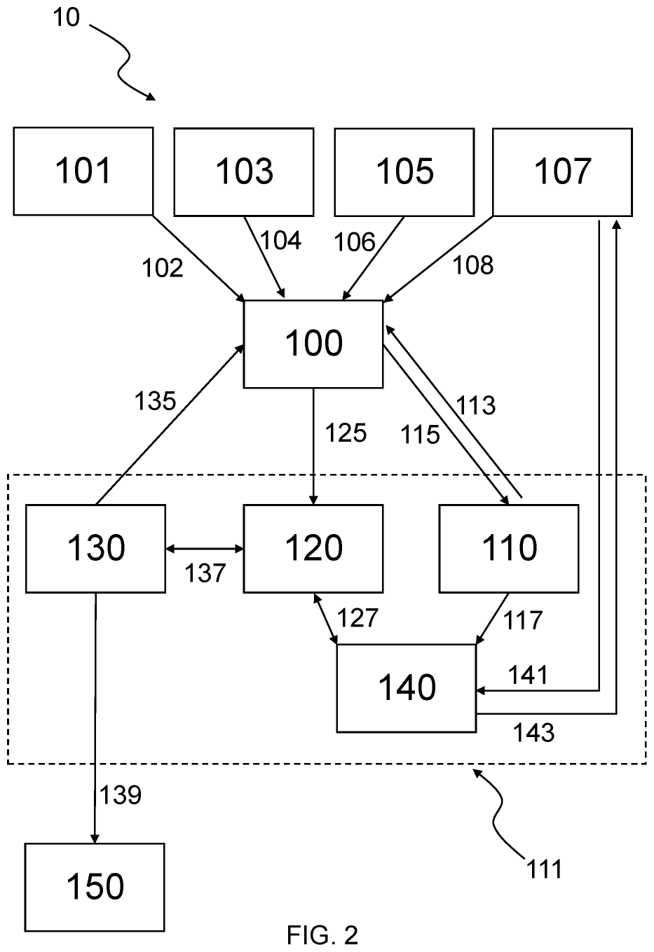

FIG. 2 shows a schematic diagram of the control system 100 and powertrain 111 of the vehicle 10.

The control system 100 is arranged to control the powertrain 111 of the vehicle. The term powertrain is intended to encompass a system comprising one or more power sources and a drivetrain coupled to the one or more power sources. The powertrain 111 comprises an internal combustion engine 110, an electric machine 120 and a battery 130. In this example, the battery 130 is arranged to supply electrical energy 137 to, and receive electrical energy 137 from, the electric machine 120. The internal combustion engine 110 and electric machine 120 may collectively be referred to as a single power source or as two power sources. Both of the internal combustion engine 110 and electric machine 120 transfer torque 117, 127 to a drivetrain 140 of the powertrain 111. The drivetrain 140 includes a gearbox and may include further components such as a torque splitter, a torque converter, a differential, and wheels of the vehicle 10. The further components may be part of the drivetrain 140 in addition to the gearbox or the gearbox may be separate from the drivetrain 140.

It will be understood that this represents only one possible vehicle architecture according to embodiments of the invention and that other vehicle architectures are within the scope of the invention, such as architectures with a separate electric motor and electric generator.

The control system 100 as illustrated in FIG. 2 comprises one controller, although it will be appreciated that this is merely illustrative and any number of controllers may be included. The control system 100 comprises one or more processors, the one or more processors being collectively configured to control the powertrain of the vehicle as described below. The controller comprises processing means and memory means. The processing means may be one or more electronic processing devices which operably execute computer-readable instructions. The memory means may be one or more memory devices. The memory means is electrically coupled to the processing means. The memory means is configured to store instructions, and the processing means is configured to access the memory means and execute the instructions stored thereon.

As shown in FIG. 2, the control system 100 may provide signals 115, 125 to the internal combustion engine 110, and/or to the electric machine 120, to deliver a certain amount of torque. For example, the control system 100 may output signals to a powertrain control module (PCM). In the case of the internal combustion engine 110, the signal 115 may be to the PCM to advance or retard ignition timing, or to increase or decrease a fuel/air mixture flow rate into the engine 110. Signals may be outputted by publication on an in-vehicle network (e.g., CAN or FlexRay bus) and received or inputted by reading the published information.

The battery 130 may supply electrical energy 137 to the electric machine 120 to generate a torque and may supply electrical energy 139 to electrical vehicle components, such as heaters, fans, displays etc. The battery may supply information regarding the electricity 139 supplied to other electrical devices 150 to the control system 100.

The control system 100 may receive information 135 from the battery 130. Examples include one or more of: a state of battery charge; a battery temperature; and an indication of battery health. Overall, the information 135 received from the battery may be indicative to the control system 100 of a battery discharge capability, which is the rate at which a battery may supply energy to the electric machine 120 and to other electrical devices 150 of the vehicle 10. In some examples, the battery 130, or a battery controller thereof, may output a battery discharge capability directly to the control system 100. The battery 130, or a battery controller thereof, may output information 135 to the control system 100 that is indicative of the power supplied to the electrical devices 150.

The control system 100 comprises an input means and an output means. The input means may comprise an electrical input of the control system 100 adapted to read the signals on the in-vehicle network. The output means may comprise an electrical output of the controller 100 adapted to publish the signals on the in-vehicle network. The output means may be arranged to output a signal 115 for controlling the engine 110, for example, by increasing or decreasing the torque output by the engine. The output means may be arranged to output a signal 125 for controlling the electric machine 120, for example, by increasing or decreasing the torque output by the electric machine.

The control system 100 is arranged to receive torque demand data 102 from a torque demand input device 101, such as an accelerator pedal. The control system 100 may then determine a required torque to be generated by the engine 110 and electric machine 120 based at least partially on the received torque demand data 102. The control system 110 may then output control signals 115, 125 to control the engine 110 and the electric machine 120 in order to generate the required torque. The torque demand data 102 may be referred to as a torque demand or, in embodiments when the driver is in manual control of the vehicle, a driver torque demand. The torque demand data may be a current torque demand. A first input signal may comprise the torque demand data 102. A current torque demand signal may contain information indicative of the current torque demand.

The control system 100 is arranged to receive a driving mode signal 104 from a driving mode selector 103, which may take the form of a driving mode selector switch, or may be taken from a touch-screen, or other such input to a human-machine interface of the vehicle. The driving mode may be selected by the driver depending on the desired behaviour of the vehicle. For example, when it is desired that a vehicle reacts quickly to a driver input and achieves high accelerations, a “sport” mode may be selected, whereas a “comfort” mode may be selected when a less reactive driving mode is desired. The control system 100 may determine a required torque based at least partially on the driving mode signal 104.

The control system 100 is arranged to receive a vehicle condition signal 106 from a vehicle condition sensor 105. The vehicle condition sensor 105 may determine properties such as a road gradient and/or a vehicle speed, and the vehicle condition signal 106 may comprise this information. The control system 100 may receive the vehicle condition signal 106 and may determine a required torque based at least partially on the information in the vehicle condition signal such as the road gradient and/or the vehicle speed. The skilled person will appreciate that vehicle condition information signal may comprise any parameter, which either directly or indirectly affects the torque requirement of an engine.

The control system is configured to receive drivetrain data 108 from a drivetrain management system 107. The drivetrain management system 107 may be referred to as a transmission control system or a transmission management system. The drivetrain control system 107 may provide drivetrain data 108 and the drivetrain data 108 may include information such as a target gear following an upshift, a gear change signal indicating that an upshift is about to occur, a torque converter slip value, indicating a level of slip from a torque converter of the drivetrain 140, and a predicted post-upshift gearbox input shaft speed. A first input signal may comprise the driver torque demand. A torque convertor slip value signal may comprise the torque converter slip value. A predicted input shaft speed signal may comprise the predicted input shaft speed of the gearbox after the expected upshift of the gearbox. In some examples, these values may be normalised values.

The control system 100 may have one or more values stored internally, such as transmission ratios of the different gears, a powertrain torque maximum capability, a blend rate for altering a torque output of the drivetrain 140, and a loss value indicative of torque losses in the powertrain. The powertrain torque maximum capability may be referred to as a power source maximum torque capability, and may take the form of a power source maximum torque capability signal.

The control system 100 may determine a predicted driver torque in a target gear based on any or all of the above-described data and may therefore determine the predicted torque required in the target gear more effectively. Further, the data included in the separate signals 102, 104, 106, 108 may be combined by a signal management system and received by the control system 100 as a single signal.

The term control system may be used to describe a specific control module, or to describe a system of sensors and modules. For instance, the drivetrain control module 107, the torque demand input device 101, the driving mode selection device 103, and the vehicle condition sensor 105 may be considered as within the same control system as the control system 100. Where a control system is described as arranged to receive a signal, it will be understood that one part or program of the control system 100 may receive the signal from a further part or program of the control system, and it is not essential that the signal is sent from a device that is external to the control system to a physically separated control system.

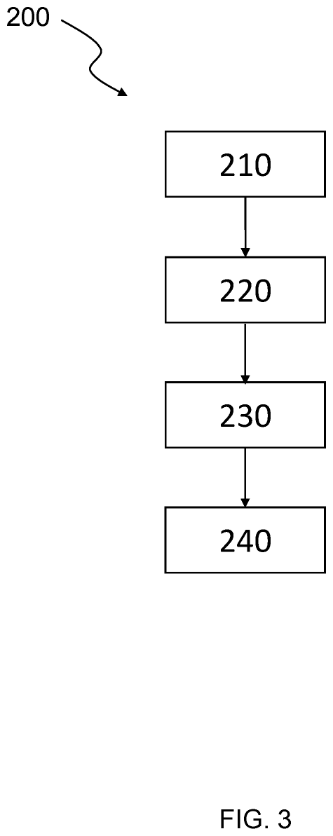

FIG. 3 is a flowchart illustrating a method 200 for determining a required torque during an upshift.

Within the method 200, at step 210, a gear change signal is received by the control system, for example from a transmission control module. The gear change signal may include an indication of a torque ratio of the current gear and/or a torque ratio of the destination gear into which the system is changing, referred to as a post-upshift torque ratio. The gear change signal may be indicative of an expected upshift of the gearbox.

At step 220, a required torque in the destination gear, also known as a post-upshift torque demand, is determined. The post-upshift torque demand may be determined based on any of the signals received by the control system as described above with reference to FIG. 2. In particular, a normalised torque demand may be determined at step 220 in dependence on the driver torque demand, the torque converter slip value and the predicted input shaft speed. The post-upshift torque demand may be included in a signal, for example a predicted torque demand signal. The predicted torque demand signal may contain information indicative of the predicted post-upshift torque demand.

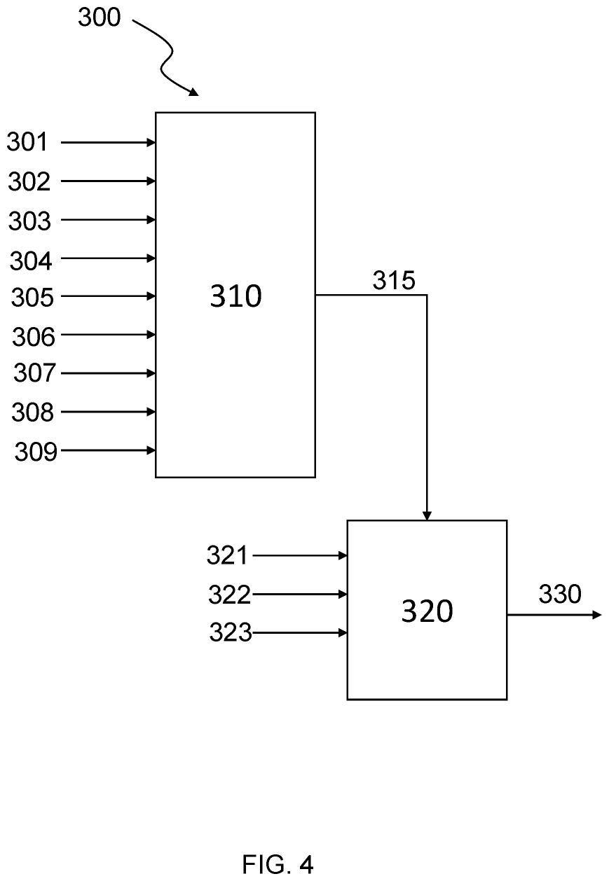

At step 230, the normalised torque demand may be processed, using the torque ratio of the gearbox after the upshift into the destination gear, also known as the post-upshift torque ratio. At step 230, the predicted post-upshift torque demand may therefore be determined. Determination of the post-upshift torque demand is described further with reference to FIG. 4 below. The predicted driver torque demand may be determined in dependence on the normalised torque demand and the gear change signal.

At step 240, the control system may output a first output signal to cause a power source to generate a torque based on the predicted driver torque demand.

In this way, the torque produced by the engine and/or the electric machine may be more well-suited to a driver demand, improving a driving experience.

FIG. 4 shows a further flowchart, illustrating how the data received by the control system may be processed for determining the predicted driver torque after the upshift. A first processing step 310 may receive inputs from the various sources. Specifically, the process 310 may receive one or more of an accelerator pedal input 301, a previous driver or terrain mode 302, a current driver or terrain mode 303, a road gradient 304, a vehicle speed 305, a high or low range requirement 307, a target gear transmission ratio, excluding torque converter slip 308, and a predicted gearbox input shaft speed in the target gear 309. The inputs 301-309, may take the form of signals, such as a road gradient signal, a vehicle speed signal, or a high or low range requirement signal, for example. Based on the inputs 301-309, the process 310 generates a normalised torque demand 315. The process 310 may comprise an algorithm that computes the normalised torque demand 315 based on the inputs 310-309, the algorithm being selected based on the desired characteristics of the vehicle. A second process 320 calculates a predicted torque demand in the target gear based on the normalised torque demand 315. The second process calculates the predicted torque demand in the target gear 330 based on the losses known within the powertrain, 321, the transmission ratio in the target gear 322, and the maximum torque capability of the powertrain 323.

By following the process 300, a more accurately predicted torque demand in the target gear may be determined.

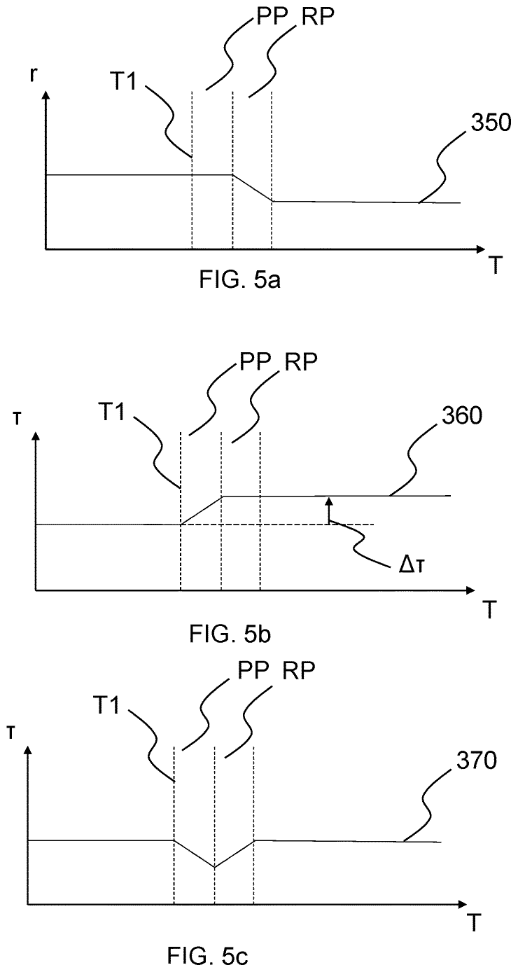

FIG. 5a shows a graph of torque ratio 350 of the gearbox against time during an upshift of the gearbox. The control system receives a gear change signal indicative of a likely upshift at a first time T1. At this time, the overall torque of the vehicle does not change and the gear ratio 350 does not change. However, the control system enters a preparation phase PP.

As shown in FIG. 5b, during the preparation phase the engine torque 360 increases. This increase may help to account for the upcoming change in gear ratio during the subsequent ratio phase RP. Further, as shown in FIG. 5c, the electric machine torque 370 may decrease during the preparation phase. The decrease in electric machine torque 370 may be equal to the increase in engine torque 360 so that the overall torque may be unaffected.

Once the engine torque 360 has increased by a sufficient amount AT, the control system may leave the preparation phase PP and enter the ratio phase RP. The increase in torque AT may be referred to as a torque modulation, as it is an alteration in torque that may be applied to a base torque demand to alter the base torque demand by a value AT. The value of AT is intended to match the torque increase required during the upshift due to the torque ratio decrease during the subsequent ratio phase RP.

In the ratio phase RP, the torque ratio 350 of the gearbox changes from the torque ratio in a first gear to the torque ratio in a second gear. The torque ratio may change gradually over time as a clutch may be applied to the second gear as a clutch is released from the first gear. Consequently, the gearbox may have an effective torque ratio intermediate the torque ratios of the first and second gears during the ratio phase RP.

During the ratio phase RP, the engine torque 360 may be maintained constant and the electric machine torque 370 may be increased. The increase in electric machine torque 370 and decrease in torque ratio 350 may be managed such that the product of the electric machine torque 370 and the torque ratio 350 is substantially constant. At the end of the ratio phase, the electric machine torque 370 may be returned to the same value as before the preparation phase PP.

The overall torque, calculated as a sum of the engine torque 360 and the electric machine torque 370, may be managed such that the product of the overall torque and the torque ratio 350 before the preparation phase PP is the same as the product of the overall torque and the torque ratio 350 after the ratio phase RP.

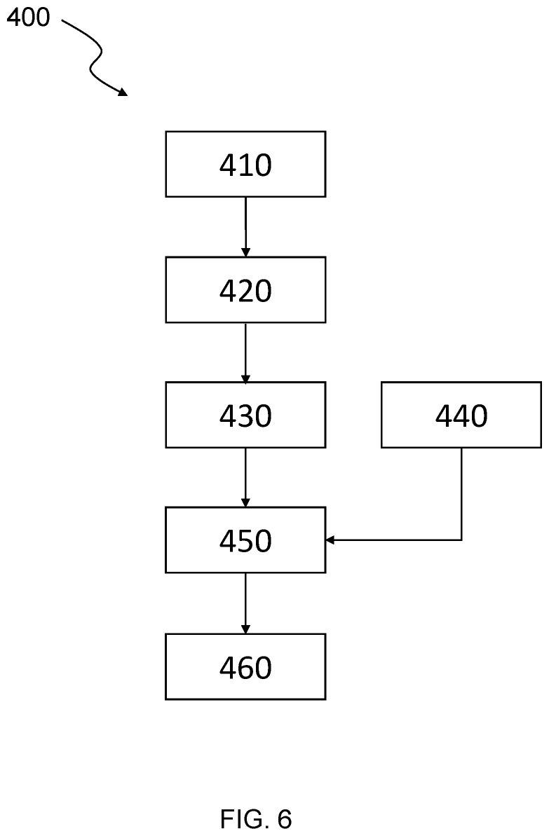

FIG. 6 shows a flowchart 400 for determining a torque modulation. At step 410, a gear change input signal is received by the control system from the drivetrain management system, indicating that a gear change is due to occur shortly. However, it will be understood that the control system may determine that a gear change is to occur and may command the drivetrain management system 107 to effect a gear change, In this case the gear change signal may be an internal signal such as one published on a CAN bus and may be received in this way.

At step 420, a predicted post-upshift torque demand is determined. The determination may be made according to the methods described in conjunction with FIGS. 2 to 5 above or may be determined alternatively, such as by multiplying the current required torque by the torque ratio in the destination gear and dividing this value by the torque ratio of the current gear.

At step 430, a difference between the current torque demand and the predicted post-upshift torque demand is determined. This value may be referred to as a torque modulation.

At step 440, a determination is made as to whether the upshift is likely to continue. In the case that the upshift is likely to be cancelled, a first torque modulation arbitration value may be output and in the case that the gear change is likely to proceed as expected, a second torque modulation arbitration value may be output. The first gear modulation arbitration value may be 0, in the case that the gear change is likely to be cancelled completely and the vehicle should proceed in the initial gear. In the case that the gear change is to proceed exactly as is expected, a torque modulation arbitration value of 1 may be output. Based on any intermediate determination, a value between 0 and 1 may be output. The torque modulation arbitration value may be considered as a ratio of how much of the torque modulation value should be passed on to the downstream control logic.

The decision to cancel the upshift may be made by the control system or by the drivetrain management system, with a signal being sent from the decision-making part of the system to the other part of the system. The control system may anticipate a decision of the drivetrain management system to cancel the upshift by the comparison of the filtered and unfiltered torque demand.

The determination as to whether the upshift should be cancelled may be made based on a comparison of an unfiltered torque demand with a filtered torque demand or a predicted torque demand compared to an actual torque demand. The actual or unfiltered torque demand being lower than the predicted or filtered torque demand by a difference greater than a threshold value may indicate that acceleration should stop and that, optionally, the gear shift may be cancelled. In the case that acceleration should cease, a torque modulation arbitration value of 0 may be output.

At step 450, a final torque modulation value may be determined based on the torque modulation value determined at step 430 and the torque modulation arbitration value determined at step 440. The determination of the final torque modulation value at step 450 may be performed by a multiplication of the torque modulation value by the torque modulation arbitration value.

At step 460, a final torque value may be determined and output. In some embodiments, the final torque value is output as a first output signal. The final torque value may be the final torque modulation value, which may be arranged to change a torque produced by a power source, or the final torque modulation value may be added to the current torque value in order to provide a torque requirement. A first output signal may be output at step 460, the first output signal may be arranged to cause a change in torque generated by the power source in dependence on the determined difference between the predicted post-upshift torque demand and the current torque demand and the gear change signal.

It will be understood that the processing steps 450 and 440 may vary and that the torque modulation value may be arbitrated by any method, but that by providing a torque modulation value the processing at step 450 may be simplified.

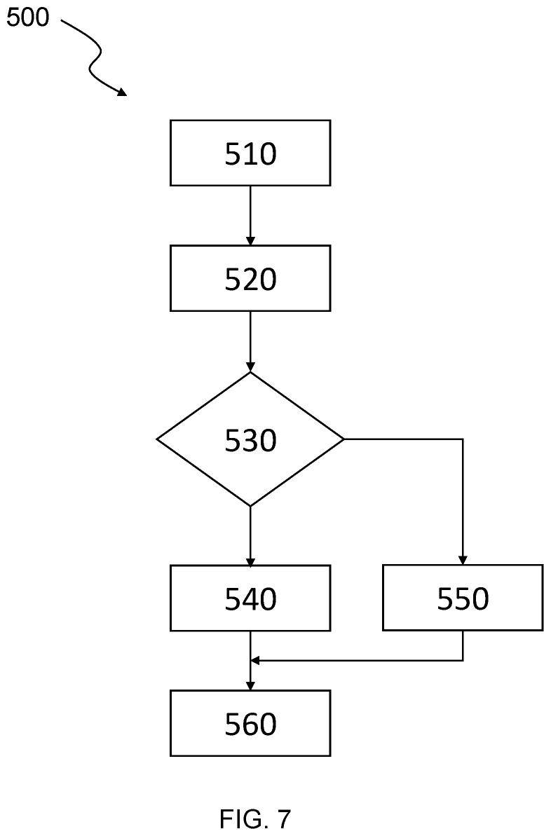

FIG. 7 shows a flowchart illustrating a method 500 of selecting a torque modulation scheme. At step 510, a gear change signal is received, indicating that an upshift of the gearbox of the vehicle is likely to occur.

At step 520, it is determined what the source of the torque demand for the vehicle is. The torque demand may be from a driver, such as via an accelerator pedal or may be via an advanced driver assistance system (ADAS) such as cruise control or adaptive cruise control. Further alternatively, the source of the torque demand may be from a fully autonomous driving program or system. The determination may be made based on a signal (torque source signal) received from a torque demand input device 101 or may be determined within the control system as the control system may be in constant communication with or may include advanced driver assistance systems or autonomous driving programs. The determined source of the torque demand for the vehicle may be output as a torque source signal.

At step 530, based on the source of the torque demand, a torque modulation scheme may be selected. If the source of the torque demand is a driver input, the method may move to step 540, and the predicted torque demand in the target gear may be determined by a first torque modulation scheme. The first torque modulation scheme may comprise the post-upshift driver torque demand prediction method described in conjunction with FIGS. 3 and 4.

If a determination is made at step 530 that the source of torque demand is an advanced driver assistance system, then a second torque modulation scheme may be used at step 550. The second torque modulation scheme may be arranged to keep the torque at the wheels of the vehicle substantially constant during an upshift by altering the overall vehicle torque such that a product of the torque generated by the power source and the transmission ratio of the drive train is substantially constant throughout the gear change. In particular, the torque modulation scheme 550 may determine the torque from the power source such that the product of the power source torque and the torque ratio before the upshift is the same as the product of the power source torque and the torque ratio after the upshift.

At step 560, the torque modulation may be further processed, such as using the torque modulation arbitration scheme described in conjunction with FIG. 6, or the torque modulation may be output to the power source in order to cause the necessary torque to be generated. The torque modulation may be output as a first output signal. The first output signal may be arranged to cause the power source to change a torque output in dependence on the selected torque modulation scheme.

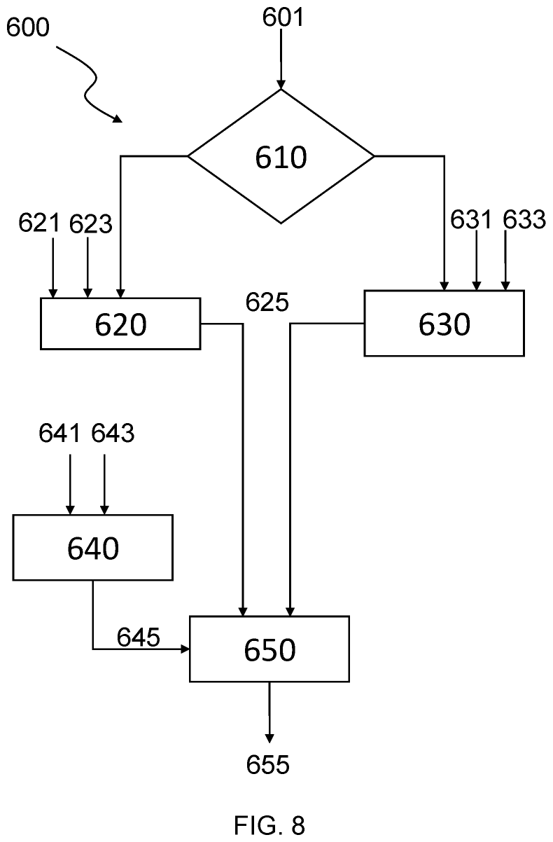

FIG. 8 shows a further flowchart of a method 600 by which a torque modulation value may be determined. Signal 601 is a torque demand source signal indicating a source of a torque demand. At step 610, a torque modulation scheme is determined based on the source of the torque demand. In the case that the torque demand is a driver torque demand, input using a driver torque input device, such as an accelerator pedal, a first torque modulation scheme 620 will be used.

For use in the first torque modulation scheme 620, a predicted driver demand in the target gear, which may also be referred to as a predicted post-upshift torque demand may be determined. The predicted post-upshift torque demand 621 may be determined as set out previously with reference to FIGS. 3 and 4. A current driver demand 623 may be used in this torque modulation calculation, which may comprise subtracting the predicted post-upshift torque demand from the current torque demand to produce a torque modulation value 625.

Alternatively, if an advanced driver assistance system is the source of the torque demand, a second torque modulation scheme 630 may be used. The second torque modulation scheme 630 may have inputs which are a primary torque request 631 from the advanced driver assistance system and a post-upshift gear ratio 633. In order to maintain the torque on the wheels at a substantially constant level throughout the upshift, the torque modulation may be calculated by multiplying the primary torque request 631 by the current gear ratio 633 and dividing the value by the post-upshift gear ratio, then subtracting the primary torque request 631. This may produce a second torque modulation value 625.

The torque modulation value 625 may be received by a torque modulation arbitration process 650 and arbitrated using a torque modulation arbitration value 645.

The torque modulation arbitration value 645 may be determined at process 640 based on a predicted torque demand 641 and a current torque demand 643. Alternatively, a filtered torque demand 641 and a raw, unfiltered torque demand 643 may be used for the torque modulation arbitration calculation 640. For example, if the filtered torque demand 641, which may be based on the raw torque demand and processed using a low pass filter, is significantly different from the raw, unfiltered torque demand 643, this may be indicative of a demand for a reduced acceleration, requiring cancellation of the upshift, and so the torque modulation arbitration value 645 may be set to 0.

A torque modulation value 655 may therefore be output as an output of the torque modulation process 600.

It will be appreciated that various changes and modifications can be made to the present invention without departing from the scope of the present application.

1. A control system for controlling a powertrain of a vehicle, the powertrain comprising a power source and a drivetrain arranged to receive torque from the power source, the drivetrain comprising a gearbox, the control system comprising one or more processors, the one or more processors being collectively configured to:
receive a gear change signal indicative of an expected upshift in the gearbox,
receive a predicted torque demand signal, the predicted torque demand signal containing information indicative of a predicted post-upshift torque demand;
receive a current torque demand signal, the current torque demand signal containing information indicative of a current torque demand;
determine, in dependence on the predicted torque demand and the current torque demand, a difference between the predicted post-upshift torque demand and the current torque demand; and
output a first output signal, the first output signal being arranged to cause a change in torque generated by the power source in dependence on the determined difference and the gear change signal.

2. The control system according to claim 1, wherein the processors are collectively configured to apply a modulation factor to the determined difference to calculate a modulated determined difference, and wherein the first output signal is output in dependence on the modulated determined difference.

3. The control system according to claim 2, wherein the processors are collectively configured to:
receive a torque demand signal indicative of a torque demand;
determine a filtered torque demand based on the torque demand signal; and
determine the modulation factor based on a comparison of the torque demand signal and the filtered torque demand.

4. The control system according to claim 2, wherein the modulation factor is between 0 and 1.

5. The control system according to claim 2, wherein applying the modulation factor to the determined difference comprises multiplying the determined difference by the modulation factor.

6. The control system according to claim 1, wherein the torque demand signal contains information indicative of at least one of:
an accelerator pedal input;
a road gradient;
a vehicle speed; and
a driving mode, and
wherein the one or more processors are collectively configured to determine the predicted post-upshift torque demand based on the accelerator pedal input; the road gradient;
the vehicle speed; and/or the driving mode.

7. A vehicle comprising the control system of claim 1.

8. A method for controlling a powertrain of a vehicle, the powertrain comprising a power source and a drivetrain arranged to receive torque from the power source, the drivetrain comprising a gearbox, the method comprising:
receiving a gear change signal indicative of an upshift of the gearbox;
receiving a predicted torque demand signal, the predicted torque demand signal containing information indicative of a predicted post-upshift torque demand;
receiving a current torque demand signal, the current torque demand signal containing information indicative of a current torque demand;
determining, in dependence on the predicted torque demand and the current torque demand, a difference between the predicted post-upshift torque demand and the current torque demand; and
outputting a first output signal based on the determined difference and the gear change signal, the first output signal being arranged to cause a change in torque generated by

9. Computer readable instructions which, when executed by a computer, are arranged to perform the method according to claim 8.
